(19) United States
(12) Patent Application Publication
(10) Pub. No.: US 2001/0033874 A1
(43) Pub. Date: Oct. 25, 2001

(54) Device for manufacturing internal motor vehicle components of multicomponent plastics material

(76) Inventors: Norbert Hoogen, Kleve (DE); Frank Rosen, Viersen (DE); Dieter Lencer, Wegberg (DE)

Correspondence Address: Friedrich Kueffner, Suite 1921, 342 Madison Avenue, New York, NY, 10173, US

(21) Appl. No.: 09/788,292

(22) Filed: Feb. 16, 2001

(30) Foreign Application Priority Data
Feb. 23, 2000 (DE) 100 08 359.5

(51) Int. Cl. B29D 9/00

(52) U.S. Cl. 425/112

(57) ABSTRACT

A device for manufacturing internal motor vehicle components of multicomponent plastics material, particularly polyurethane, wherein the internal motor vehicle components are composed of a carrier and a decorative foil which are glued together by the foamed multicomponent plastics material. The device includes a lower die part and an upper die part and a frame for supporting the decorative foil. The die cavity is sealed by a sealing rope. In the closed position of the device, the three sides of the sealing rope which do not face the die cavity are in contact and secured by the clamping frame and the lower and upper die parts. The fourth side of the sealing rope facing the die cavity is expandable in the direction toward the die cavity. The sealing rope may be attached to and movable with the clamping frame.

### BACKGROUND OF THE INVENTION

1. Field of the Invention

The present invention relates to a device for manufacturing internal motor vehicle components of multicomponent plastics material, particularly polyurethane. The components are formed of a carrier and a decorative foil which are glued together by means of the foamed multicomponent plastics material. The device is composed of a lower die part and an upper die part and a frame for the decorative foil, wherein the die cavity is sealed off by means of a sealing rope.

2. Description of the Related Art

Various types of such devices are known in the art. These devices are used for manufacturing the internal linings of automobiles. These internal linings are composed of a decorative foil of fabric, leather or the like; specifically, the internal linings are laminated with this decorative foil. In the assembled state, the decorative foil later faces the interior of the automobile. The lamination is effected by the multicomponent plastics material which foams during the manufacture and provides a so-called “soft touch”. When this internal lining is manufactured, a carrier, usually also of plastics material, is placed into the die to ensure the necessary stiffness and stability. In the finished and mounted product, this carrier is usually not visible.

When such an internal motor vehicle component is manufactured, problems occur during foaming of the multicomponent plastics materials in the area of the seal formed by the sealing rope between the lower die and the upper die. The very sticky multicomponent plastics material emerges at this location, so that it must later once again be removed from the product component. Without cleaning the product component, the following processes, such as bending or gluing, etc., cannot be carried out. The emerging plastics material also results in a contamination of the die. The clamping frame holds down the decorative foil on the lower die part. The decorative foil is usually additionally held by suction action of a vacuum.

### SUMMARY OF THE INVENTION

It is the primary object of the present invention to provide a better sealing action between the two die parts and especially to prevent the emergence of multicomponent plastics material during foaming.

In accordance with the present invention, when the die is closed, the sealing rope is in contact with and is secured in its position and shape by the frame and the upper and lower die parts on the three sides which do not face the die cavity. On the fourth side of the sealing rope which faces the die cavity, the sealing rope is expandable in the direction toward the die cavity.

Accordingly, in accordance with the present invention, a special sealing rope is used which is attached and arranged in such a way that, on the three sides that do not face the die cavity, the sealing rope is secured with respect to its position and shape; in other words, the sealing rope has no degree of freedom for movement at these three sides. The sealing rope can only move toward the die cavity. When the die is closed, this movement toward the die cavity and the carrier and the decorative foil at this location ensures that the shape of the sealing rope is adapted to these parts and the desired sealing action is obtained as a result.

In accordance with an advantageous further development of the present invention, the sealing rope is attached to the clamping frame and can be moved together with the clamping frame. When the die is closed, the bottom side of the sealing rope is in contact with the lower die part and the upper side of the sealing rope is in contact with the upper die part.

In this embodiment, when the decorative foil has been placed into the lower die part, the clamping frame with the sealing rope are moved toward the lower die part. This means that the decorative foil is held and two sides of the sealing rope are already secured. The upper die part is then moved with the carrier toward the lower die part after the multicomponent plastics material has been introduced into the die cavity. During the closing movement of the die, the carrier does not contact the sealing rope. The contact between the carrier and the sealing rope is exclusively effected by the upper die part. The sealing rope is now also secured at the third side thereof which faces the upper die part. The fourth side of the sealing rope which can expand then produces the desired sealing action relative to the die cavity and the portions of the carrier and the decorative foil in the die cavity.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention

### BRIEF DESCRIPTION OF THE DRAWING

In the drawing:

FIG. 1 is a partial sectional view of a die according to the present invention shown in the open state; and

FIG. 2 is a sectional view corresponding to FIG. 1, but with the die shown in the closed state.

### DESCRIPTION OF THE PREFERRED EMBODIMENTS

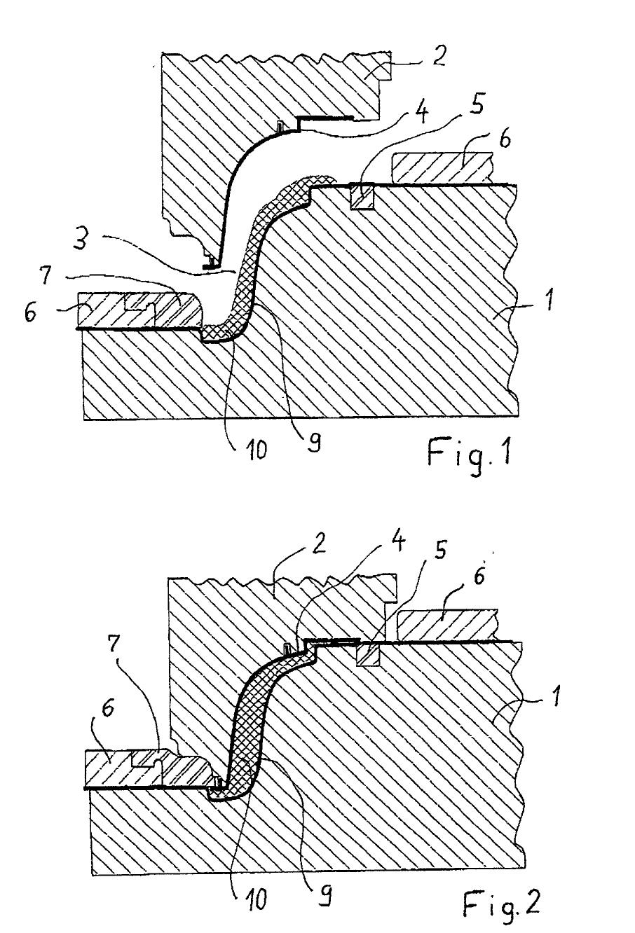

The die illustrated in FIGS. 1 and 2 is composed of a lower die part 1 and an upper die part 2. The upper die part supports the carrier 4 which is secured in various ways either mechanically or by suction by applying a vacuum. The decorative foil 9 is placed in the lower die part 1 and is secured and held by the clamping frame 6 which is moved from the top toward the lower die part 1. The decorative foil 9 is additionally placed and held in the correct position by applying a vacuum. The die cavity between the two die parts 1 and 2 is denoted by reference numeral 3. When all components are in the position illustrated in FIG. 1, the multicomponent plastics material is introduced into the die cavity by means of a manipulator. The upper die part 2 is then moved downwardly and the die is closed. The multicomponent plastics material 10 then foams.

As can be seen in FIG. 2, the sealing rope 9, which is fastened by means of a support to the clamping frame 6, is tightly clamped at three sides. The sealing rope 7 is then compressed somewhat by the upper die part 2, so that the sealing rope 7 can only expand at the fourth side which faces the die cavity 3 in order to effect a good sealing action at the portions of the carrier and the decorative foil located in this area.

When the foaming process is concluded, the die is opened and the finished internal motor vehicle component can be removed. Practically no foam emerges in the area of the sealing rope 7, so that no further processing or only little further processing is required.

The die is constructed in accordance with the shape of the internal motor vehicle component to be manufactured. In the illustrated embodiment, the sealing rope 9 is only provided at one side. A conventional sealing member 5 is provided at the other side; however, the sealing member 5 is protected by the protruding decorative foil 9. When the die is manufactured in this way, no multicomponent plastics material can emerge at all. However, other embodiments are also conceivable in which the sealing rope 7 extends around the entire die.

While specific embodiments of the invention have been shown and described in detail to illustrate the inventive principles, it will be understood that the invention may be embodied otherwise without departing from such principles.

We claim:

1. A device for manufacturing internal motor vehicle components of multicomponent plastics material, wherein each internal motor vehicle component is composed of a carrier and a decorative foil which are glued together by foamed multicomponent plastics material, the device comprising a lower die part and an upper die part forming a die cavity in a closed position of the device, and a clamping frame for supporting the decorative foil, further comprising a sealing rope for sealing the die cavity, the sealing rope having three sides not facing the die cavity and a fourth side facing the die cavity, wherein, in the closed position, the three sides not facing the die cavity are in contact with and secured with respect to shape and position by the clamping frame and the lower die part and the upper die part, and wherein the fourth side facing the die cavity is expandable in a direction toward the die cavity.

2. The device according to claim 1, wherein the multicomponent plastics material is polyurethane.

3. The device according to claim 1, wherein the sealing rope is attached to and movable together with the clamping frame such that, in the closed position, a bottom side of the sealing rope is in contact with the lower die part and an upper side of the sealing rope is in contact with the upper die part.
